(19) United States
(12) Patent Application Publication
(10) Pub. No.: US 2010/0224811 A1
(43) Pub. Date: Sep. 9, 2010

(54) WATER SUPPLY FAUCET ASSEMBLY

(76) Inventor: Chiu-Lin CHANG, (US)

Correspondence Address: Lu & Associates, P.C., P.O. Box 1380, HAVERTOWN, PA, 19083, US

(21) Appl. No.: 12/397,699

(22) Filed: Mar. 4, 2009

(51) Int. Cl. F16K 31/44

(52) U.S. Cl. 251/231

(57) ABSTRACT

The present invention discloses an improved water supply faucet assembly of a washing machine, and the water supply faucet includes a valve chamber disposed at the bottom of the interior of a water faucet body and provided for connecting a precision ceramic valve module having a valve spindle, a water isolating plate, a water control plate, a water outlet plate and a water-resistance ring, and a screw hose secured to the bottom of the water faucet body for sealing and limiting the position of the ceramic valve module, such that after the valve spindle is passed through a penetrating hole at the top of the faucet body of the washing machine, the valve spindle can be coupled to a water control handle, so as to constitute the water supply faucet assembly of the invention.

### BACKGROUND OF THE INVENTION

1. Field of the Invention

The present invention relates to a washing machine, in particular to a water supply faucet of the washing machine.

2. Description of the Related Art

In general, a conventional water supply faucet of a washing machine adopts a ball valve for controlling and switching the supply of water, but the watertight connection of the ball valve with a faucet body is usually poor, and thus it is necessary to install a water resistant gasket to achieve the expected watertight effect. However, the water resistant gaskets of this type are generally not made of a wear resistant material and are worn easily during the process of switching the water supply. As a result, the water resistance effect becomes very poor, and leakages may occur easily. Obviously, such conventional water supply faucet requires improvements.

To integrate a present existing precision ceramic valve into a water faucet body, manufacturers have to reduce the overall volume of the precision ceramic valve and increase the size of the water resistant faucet body before the precision ceramic valve can be installed in the water supply faucet successfully. Since the water resistant faucet body is made of copper and the international copper price remains very high, the increase of the water faucet body size naturally causes a higher cost. This arrangement not only increases the size of the water resistant faucet body, but also provides no contribution to the improvement of water output or even reduces the water output due to the reduced volume of the precision ceramic valve. The prior art fails to meet the cost-effective requirement and demands immediate solutions.

### SUMMARY OF THE INVENTION

Therefore, it is a primary objective of the present invention to provide an improved water supply faucet assembly, such that components of a ceramic valve module can be integrated into the water faucet body directly without increasing the size of the water faucet body or using an additional valve casing to lower the material cost and avoid increasing the size of the water faucet body.

Another objective of the present invention is to maintain the water output and the water resistant effect without increasing the size of the water faucet body. To achieve the foregoing objectives, the present invention provides an improved water supply faucet comprising a valve chamber disposed at the bottom of the interior of a water faucet body and provided for connecting components module such as a valve spindle, a water isolating plate, a water control plate, a water outlet plate and a water-resistance ring of a related precision ceramic valve, and a screw hose secured to the bottom of the water faucet body for sealing and limiting the position of the ceramic valve module, such that after the valve spindle is passed through a penetrating hole at the top of the faucet body of the washing machine, the valve spindle can be coupled to a water control handle. The water supply faucet assembly of the invention not only simplifies its structure and assembling procedure, but also overcomes the shortcomings of the conventional easy-wearing ball valve assembly by means of the excellent water resistance and wear resistance of the ceramic valve module, and waives the use of an additional valve casing by integrating the components of the ceramic valve module directly into the water faucet body, so as to maintain or enhance the water output without increasing the size of the water faucet body and lower the production cost to achieve the practical and cost-effective effects.

### BRIEF DESCRIPTION OF THE DRAWINGS

FIG. 1 is a schematic view of an assembly in accordance with a preferred embodiment of the present invention;

FIG. 2 is an exploded view of an assembly in accordance with a preferred embodiment of the present invention;

FIG. 3 is another exploded view of an assembly in accordance with a preferred embodiment of the present invention;

FIG. 4 is a cross-sectional view of an assembly in accordance with a preferred embodiment of the present invention; and

FIG. 5 is a schematic view showing a structural relation of an assembly in accordance with a preferred embodiment of the present invention.

### DETAILED DESCRIPTION OF THE PREFERRED EMBODIMENTS

The structural assembly, technical characteristics and effects of the present invention will become apparent from the following detailed description of preferred embodiments taken with the accompanying drawings.

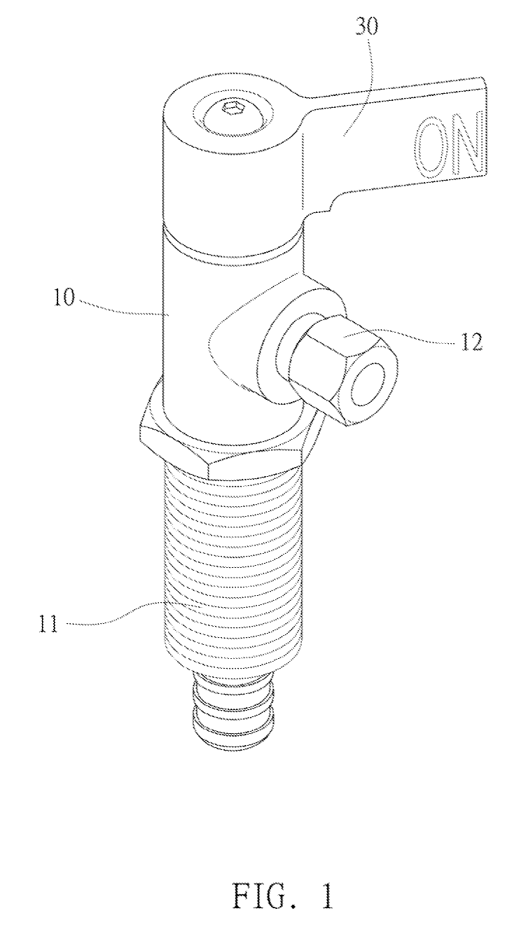

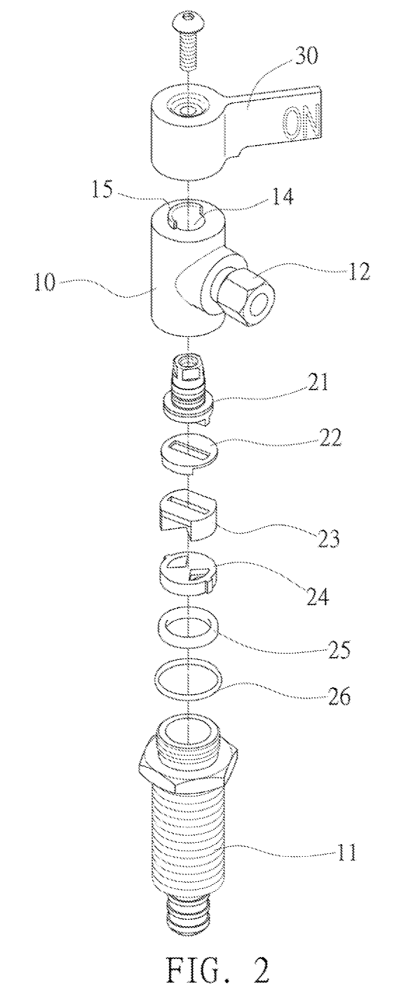

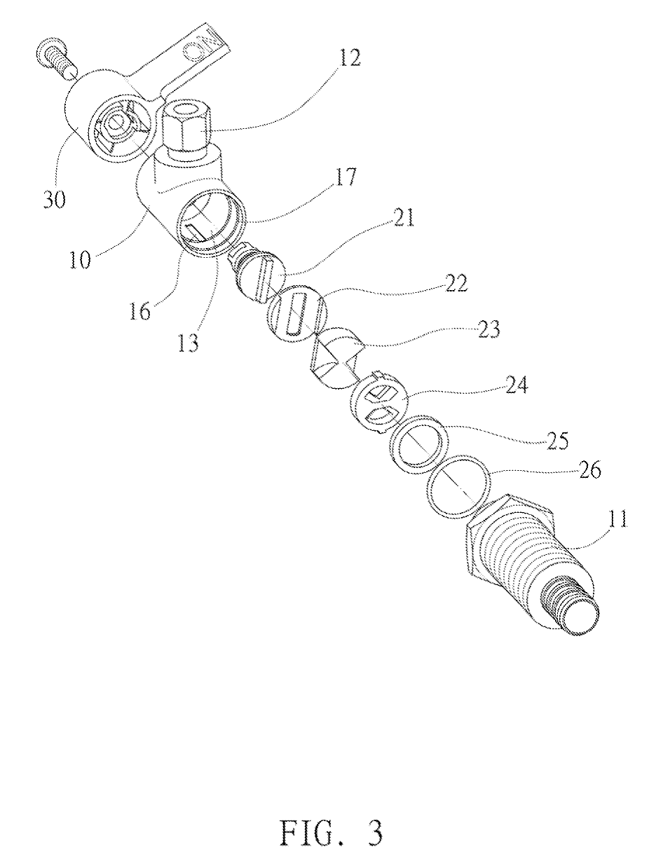

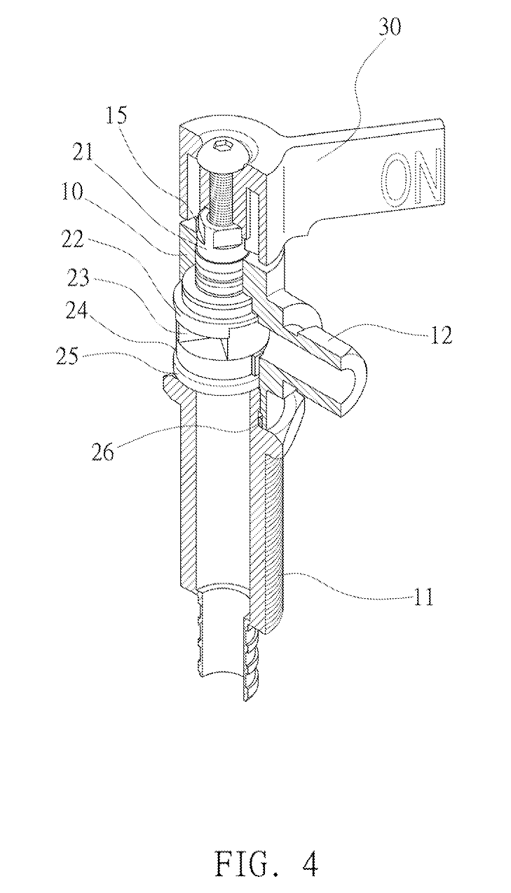

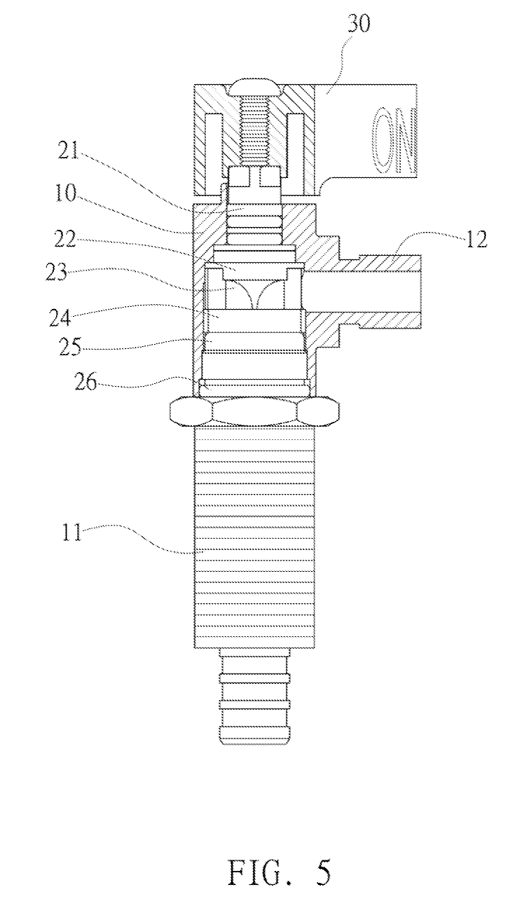

With reference to FIG. 1 for a schematic view, FIGS. 2 and 3 for exploded views, FIG. 4 for a cross-sectional view, and FIG. 5 for a schematic view of a structural relation in accordance with a preferred embodiment of the present invention respectively, the water supply faucet constructed according to the structural design of a water supply faucet of a washing machine of the present invention comprises: a three-way water faucet body 10; a screw hose 11 coupled to the bottom of the water faucet body 10 for connecting a water pipeline (not shown in the figure) and a water outlet joint 12 laterally installed at the middle section of the water faucet body 10 for connecting a water outlet pipeline (not shown in the figure) to introduce water into a washing tank of the washing machine; a valve chamber 13 installed inside and at the bottom of the water faucet body 10 to integrate components such as a valve spindle 21, a water isolating plate 22, a water control plate 23, a water outlet plate 24 and a water-resistance ring 25 of a precision ceramic valve module into the water faucet body 10 and having a penetrating hole 14 with a diameter corresponding to the valve spindle 21 and disposed at the top of the valve chamber 13, a semicircular limit plate 15 having an appropriate width and extended from the rear edge of the external side of the penetrating hole 14 for controlling and limiting the position of a water control handle 30, a pair of guide slots 16 disposed at a lower section of the internal rim of the valve chamber 13, such that when the water outlet plate 24 is installed, the water outlet plate 24 is matched with a protruding plate 241 protruded individually from both sides of the water outlet plate 24 for the installation, and an internal screw thread 17 disposed at a lower end of the valve chamber 13 and provided for coupling and securing the screw hose 11, such that the valve chamber 13 of the water faucet body 10 can be used for installing components such as the valve spindle 21, water isolating plate 22, water control plate 23, water outlet plate 24 and water-resistance ring 25 of the precision ceramic valve module sequentially from the bottom of the water faucet body 10, and a rod portion of the valve spindle 21 can be passed through and protruded from the penetrating hole 14 and coupled to a water control handle 30, and the screw hose 11 is coupled and secured to the bottom of the water faucet body 10 for accomplishing a watertight effect by installing a water-resistance ring 26 at the coupling interface. By securing the screw hose 11, the precision ceramic valve module in the valve chamber 13 can be sealed and its position can be limited to maintain a good connection of each component of the ceramic valve module with the water faucet body 10, so as to constitute the improved water supply faucet assembly of a washing machine in accordance with the present invention.

With the aforementioned structural design, the components including the valve spindle 21, water isolating plate 22, water control plate 23, water outlet plate 24 and water-resistance ring 25 of the precision ceramic valve module of the invention is used to replace the conventional ball valve structure to enhance the wear resistance and water resistance and overcome the shortcomings of the conventional ball valve. In the meantime, the components including the valve spindle 21, water isolating plate 22, water control plate 23, water outlet plate 24 and water-resistance ring 25 of the precision ceramic valve module are installed and integrated directly into the valve chamber 13 inside the water faucet body 10 without requiring an additional valve casing, and finally the precision ceramic valve module is plugged into the water faucet body 10 to save the material cost of the additional valve casing, and lower the production cost of the water faucet body 10 by avoiding the increase of the size resulted from the unnecessary valve casing. In addition to the improvement of practical applications, the invention can also maintain or enhance the water output to lower the cost and achieve the cost-effectiveness effect to break through the dilemma of maintaining expected functions and a low cost for present existing water supply faucets of washing machines.

In the structural design of the water supply faucet for washing machines in accordance with the present invention, the conventional ball valve structure with the easy wearing and leaking issues can be enhanced. Particularly the precision ceramic valve is used to replace the conventional ball valve. To avoid an increased size of the water faucet body and a higher cost resulted from the installation of the ceramic valve, the present invention provides a special design for the interior of the water faucet body, wherein the valve chamber is disposed at the bottom of the water faucet body and provided for installing the components of the precision ceramic valve module directly to waive the use of an additional valve casing, and the screw hose is installed at the bottom for limiting the position of the ceramic valve module. Such arrangement not only lowers the cost, but also provides a simple and easy installation. The water supply faucet for washing machines in accordance with the present invention achieves the expected wear resistance and water resistance effects, and also maintains or enhances the water output. The invention can improve over the prior art and comply with the patent application, and thus is duly filed for patent application.

What is claimed is:

1. An improved water supply faucet assembly of a washing machine, comprising a water faucet body, a screw hose coupled to the bottom of the water faucet body for supplying water, a water outlet joint laterally coupled to the middle section of the water faucet body for connecting a water outlet pipeline, a precision ceramic valve module installed in the water faucet body, a water control handle coupled to a valve spindle of the ceramic valve module protruded from the top of the water supply faucet for controlling the components of the ceramic valve module to control the water supply of the water supply faucet, characterized in that the water faucet body includes a valve chamber disposed at the bottom of the water faucet body, a penetrating hole disposed at the top of the valve chamber for passing a valve spindle of the ceramic valve module to coupled a water control handle, a pair of guide slots disposed at the lower section of the internal rim of valve chamber for installing and positioning the components of the ceramic valve module, and an internal screw thread disposed at a lower end of the valve chamber and provided for securing the screw hose to seal and limit positions of the components of the ceramic valve module, such that the valve chamber in the water faucet body can be used for installing and integrating the components of the ceramic valve module directly inside the water faucet body to waive the use of an additional valve casing.

2. The improved water supply faucet assembly of claim 1, wherein the water faucet body includes a penetrating hole disposed at and penetrated through the top of the water faucet body, and a semi-circular limit plate with an appropriate width extended from a rear distal portion of an external side of the water faucet body for controlling and limiting the position of the water control handle.

3. The improved water supply faucet assembly of claim 1, wherein the water control valve module is comprised of a valve spindle, a water isolating plate, a water control plate, a water outlet plate and a water-resistance ring, and installed and integrated directly into the valve chamber of the water faucet body without requiring an installation of a valve casing in advance.

4. The improved water supply faucet assembly of claim 1, further comprising a water-resistance ring installed at an interface of coupling and securing the screw hose with the water faucet body for achieving a watertight effect.
